(19) United States
(12) Patent Application Publication
(10) Pub. No.: US 2013/0119825 A1
(43) Pub. Date: May 16, 2013

(54) ASSEMBLY FOR CONVERTING MOTION INTO ELECTRICAL POWER

(71) Applicants: Subbiah NATARAJAN, Hyderabad (IN); Madhava Prasad TUNUGUNTLA, Hyderabad (IN); Ravindra GARDAS, Hyderabad (IN)

(72) Inventors: Subbiah NATARAJAN, Hyderabad (IN); Madhava Prasad TUNUGUNTLA, Hyderabad (IN); Ravindra GARDAS, Hyderabad (IN)

(21) Appl. No.: 13/293,449

(22) Filed: Nov. 10, 2011

(51) Int. Cl. H02N 2/18

(52) U.S. Cl. 310/339

(57) ABSTRACT

An assembly for converting motion into electrical power includes a piezoelectric crystal which is deformed in response lateral movements of a rotating mass. A hydraulic force transmission unit can be used to transmit a force or a motion from a rotating mass to the piezoelectric crystal. The hydraulic unit can include a force multiplication system which generates a force that is greater in magnitude than the force applied by the rotating mass.

### BACKGROUND

Many types of machinery include rotors or rotating members. The rotors or rotating members are typically mounted in bearings which hold the rotating members within a frame or housing.

If the rotating members are perfectly balanced, there will be essentially no motion in a direction perpendicular to the rotational axis. However, in most real-world machinery, there is always at least a small imbalance in the rotating mass. As a result, during rotation, the rotating mass generates a force that acts in a direction perpendicular to the rotational axis. Although the bearings in which a rotating member is mounted are designed to withstand this force, the force acts in a manner that tends to cause lateral movement of the rotating member in a direction perpendicular to the rotational axis. These forces, and any actual lateral movement of the rotating mass, typically are not used in any fashion to accomplish any work. These forces, and any corresponding movements typically represents energy that is simply lost, and which performs no useful function.

### BRIEF SUMMARY OF THE INVENTION

In a first aspect, the invention may be embodied in an assembly for converting motion into electrical power that includes a frame, a rotating member mounted on the frame, a bearing that, at least in part, rotationally supports the rotating member on the frame, and at least one electrical power generating unit mounted on the frame and having a movable member that is operatively coupled to the bearing such that movements of the bearing cause movement of the movable member. The at least one electrical power generating unit converts movement of the movable member into electrical power.

In a second aspect, the invention may be embodied in an electrical power generating unit that converts movement into electrical power which includes a housing, a piezoelectric element mounted on the housing, a movable member, and a force transmitting unit. The force transmitting unit is operatively coupled to the movable member and the piezoelectric element such that movements of the movable member cause the force transmitting unit to generate a force that is operatively coupled to the piezoelectric element. A force applied to the piezoelectric element by the force transmitting unit causes the piezoelectric element to generate a voltage.

### BRIEF DESCRIPTION OF THE DRAWINGS

FIG. 1 is a perspective view of an assembly for converting motion into electrical power;

FIG. 2 is a cross-sectional view of the assembly illustrated in FIG. 1;

FIG. 3 is a perspective view of a bearing housing which can be incorporated into a machine having a rotating member;

FIG. 4 is partial cross-sectional perspective view of a portion of the bearing housing illustrated in FIG. 3;

FIG. 5 is a perspective view of the bearing housing of FIG. 3 with a bearing mounted on the plate and an assembly for converting motion into electrical power mounted beneath the bearing;

FIG. 6 is a partial cross-sectional view of the assembly illustrated in FIG. 5;

FIG. 7 is a diagram of a bearing housing which includes multiple assemblies for converting motion into electrical power;

FIG. 8 is a diagram of a bearing housing having multiple assemblies for converting motion into electrical power with remote moveable members;

FIG. 9 is a diagram of a bearing housing having multiple assemblies for converting motion into electrical power that are coupled to a single remote moveable member;

FIG. 10 is a cross-sectional view of a second embodiment of an assembly for converting motion into electrical power

FIG. 11 is a perspective, cross-sectional view of a fluid filled bearing designed to receive a power generating unit as illustrated in FIG. 1;

FIG. 12 is a partial perspective view of a rotating shaft that can be used in the fluid filled bearing illustrated in FIG. 11;

FIG. 13 is a perspective, cross-sectional view of the fluid filled bearing with a rotating shaft mounted therein;

FIG. 14 is an enlarged perspective, cross-section view illustrating a rotational shaft mounted in a fluid filled bearing;

FIG. 15 is a perspective, cross-sectional view of the fluid filled bearing with a rotating shaft and a power generating unit mounted therein;

FIG. 16 is a cross sectional view of a rotating shaft that can be used in a fluid filled bearing as illustrated in FIG. 1; and

FIG. 17 is a cross sectional view of another embodiment of a rotating shaft that can be used in a fluid filled bearing as illustrated in FIG. 1.

### DETAILED DESCRIPTION OF PREFERRED EMBODIMENTS

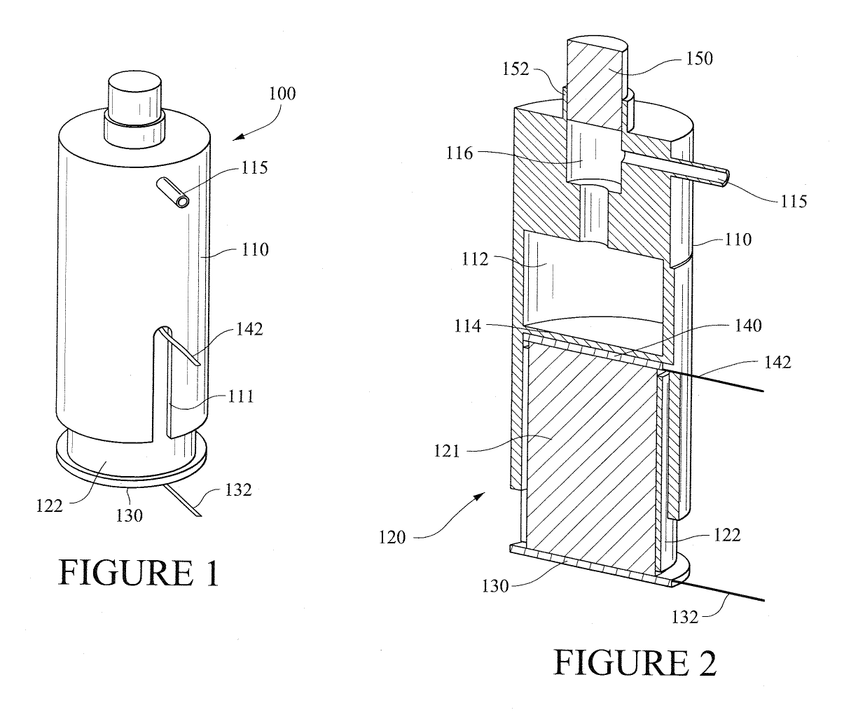

FIGS. 1 and 2 illustrate a first embodiment of an assembly which can convert motion into electrical power. The assembly illustrated in FIGS. 1 and 2 could be used to harness small lateral movements of a rotating body which occur as the rotating body is rotating within a machine.

The assembly 100 includes a housing 110 having a hydraulic reservoir 112. A piezoelectric element 120 is mounted in a lower portion of the housing 110. A moveable member or piston 150 is mounted at the top of the housing 110.

The piezoelectric element 120 includes a piezoelectric crystal 121 having sidewalls surrounded by a layer of insulation 122. A first electrode 130 is attached to a bottom of the piezoelectric crystal 121. A second electrode 140 is attached to the top of the piezoelectric crystal 121. A first electrical lead 132 is attached to the first electrode 130, and a second electrical lead 142 extends from the second electrode 140.

When a force is applied to the piezoelectric crystal 121 to deform the crystal, the piezoelectric crystal 121 generates an electrical voltage between the first and second electrodes 130, 140 which appears on the first and second electrical leads 132, 142. The insulation layer 122 prevents the generated electrical voltage from being applied to the housing 110.

As illustrated in FIG. 1 a slot 111 is cut through the housing 110 to allow the second electrical lead 142 to protrude out of the housing 110. In alternate embodiments, a hole or aperture in the housing 110 may allow the second electrical lead 142 to protrude out of the housing 110. In still other alternate embodiments, the second electrical lead 142 may be routed down the inside of the housing 110 between the inner wall of housing 110 and the outer side of the insulation layer 122. This would allow the second electrical lead 142 to join the first electrical lead 132 at the base of the housing 110.

The hydraulic reservoir 112 inside the housing 110 is filled with a hydraulic fluid through a hydraulic fill line 115. One or more valves may be provided on the hydraulic fill line 115 so that the amount of fluid in the hydraulic reservoir 112 and a hydraulic pressure in the hydraulic reservoir 112 can be appropriately adjusted and maintained. Also, as will be explained below, the amount of hydraulic fluid delivered through the hydraulic fill line can be used to adjust a position of the piston 150 relative to the housing 110.

A hydraulic passageway 116 feeds from the hydraulic reservoir 112 to one side of the moveable member or piston 150.

The piston or movable member 150 is mounted inside a cylindrical bore 152 at the top of the housing 110. A hydraulic passageway 116 leads from the cylindrical bore 152 into the hydraulic reservoir 112. Once the hydraulic reservoir 112 and the hydraulic passageway 116 are filled with hydraulic fluid, the hydraulic fill line 115 is closed off so that the hydraulic reservoir 112 and the hydraulic passageway 116 constitute a closed vessel having a particular volume.

If a force is applied to the top of the piston 150 to push the piston downward, the bottom surface of the piston 150 applies a force to the hydraulic fluid in the hydraulic passageway 116. This force is transmitted through the hydraulic fluid to a base 114 of the hydraulic reservoir 112. Because the hydraulic fluid is essentially incompressible, downward movement of the piston 150 causes the bottom wall 114 of the hydraulic reservoir 112 to flex downward, which applies a force to the piezoelectric crystal 121 that deforms the piezoelectric crystal 121. Deformation of the piezoelectric crystal 121 causes the piezoelectric crystal 121 to generate an electrical voltage that is seen on the first and second electrical leads 132, 142.

A force applied to the piston 150 which causes the piston 150 to move downward will actually be multiplied by the hydraulic mechanism within the housing 110. The bottom wall 114 of the hydraulic reservoir 112 has a much greater area than the bottom surface of the piston 150. As a result, the force applied to the piezoelectric crystal 121 through the bottom wall 114 of the hydraulic reservoir 112 will be greater than the force applied to the piston 150. Conversely, the piston 150 will actually move a greater distance downward than the bottom wall 114 of the hydraulic reservoir 112. However, because it is not necessary for a piezoelectric crystal to be greatly deformed in order to produce a large voltage, smaller movements of the bottom wall 114 of the hydraulic reservoir 112 do not pose a problem and are actually desirable. Thus, the arrangement illustrated in FIG. 2 provides a force multiplication which is beneficial in applying a greater force to the piezoelectric crystal 121 than is applied to the piston.

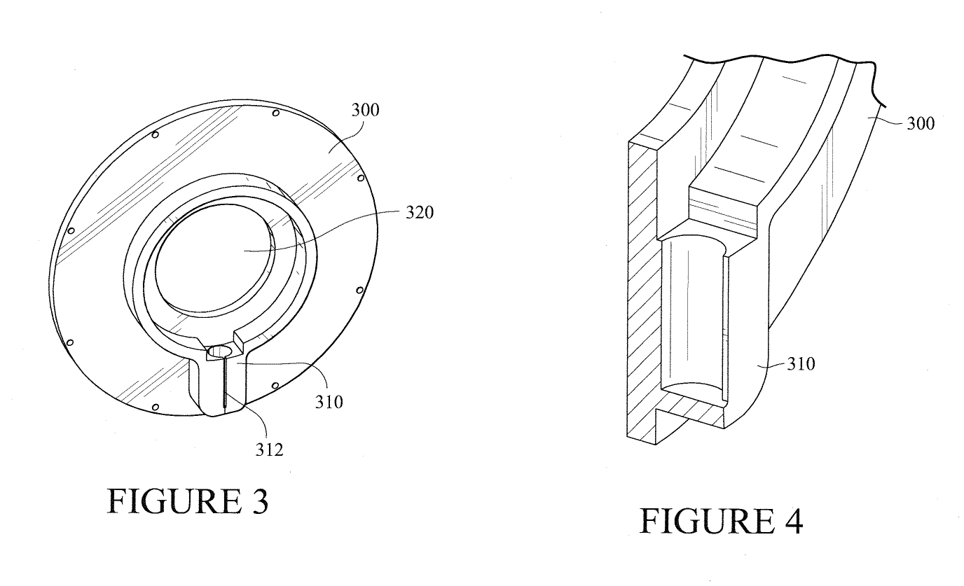

An assembly for converting motion into electrical power as illustrated in FIGS. 1 and 2 can be mounted on machinery which includes a rotating element such as a rotor or a shaft. When properly mounted on such machinery, small lateral movements perpendicular to the rotational axis of the rotating element, or the bearings that support the rotating element, can be harnessed to cause movement of the piston 150 of the assembly 100. These movements of the piston 150 in turn apply a force to the piezoelectric crystal 121 to cause the generation of an electrical voltage. One such arrangement is illustrated in FIGS. 3-6.

FIG. 3 illustrates a bearing housing 300 which can be part of a machine which includes a rotating member. An electrical power generating unit mounting portion 310 is located adjacent to where a bearing would be mounted on the bearing housing 300. An electrical power generating unit as illustrated in FIGS. 1 and 2 will be mounted in the mounting unit 310. The first and second electrical leads 132, 142 of the electrical power generating unit would protrude out of a slot 312 in the mounting unit 310.

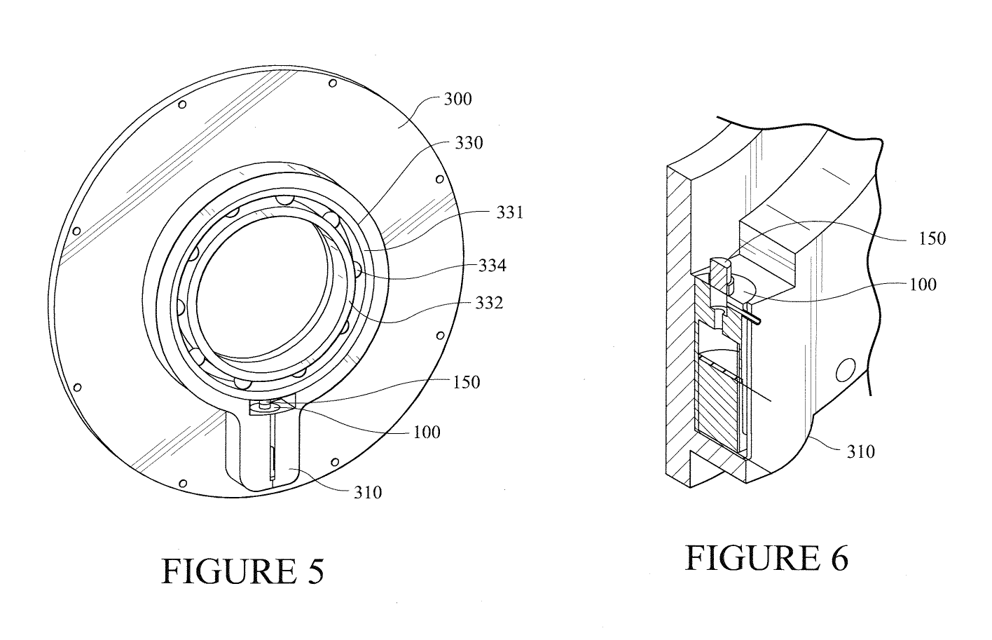

FIG. 5 shows a bearing housing 300 with a bearing 330 mounted therein. The bearing 330 includes an outer race 331, an inner race 332 and a plurality of balls 334 mounted between the inner race 332 and the outer race 331.

As also illustrated in FIG. 5, an electrical power generating unit 100 is mounted in the mounting portion 310 of the bearing housing 300. The piston or moveable member 150 of the power generating unit 100 abuts the outer surface of the outer race 331 of the bearing 330. FIG. 6 provides a more detailed cross-sectional view illustrating how the electrical power generating unit 100 is mounted in the mounting portion 310 of the bearing housing 300.

During assembly of this mechanism, once the power generating unit 100 and the bearing 330 have been mounted on the bearing housing 300, the position of the piston 150 in the housing 110 of the power generating unit 100 would be adjusted so that the top surface of the piston directly abuts the outer surface of the bearing 330. This could be done by adding hydraulic fluid through the hydraulic fluid fill line 115 to cause the piston 150 to move upward until it abuts the bearing 330. Once the piston is in contact with the bearing, the hydraulic fluid fill line 115 would be closed off to create a closed hydraulic system.

The filling of hydraulic fluid could also be done in a manner that creates a certain amount of hydraulic pressure within the closed hydraulic system. This would ensure that any movement of the piston would result in immediate flexing of the piezoelectric crystal 121.

In alternate embodiments, a mechanical adjustment mechanism could be provided between the bottom of the power generating unit 100 and the bottom of the mounting portion 310 of the bearing housing 300. The mechanical adjustment mechanism could be used to adjust the position of the power generating unit 100 within the bearing housing 300 to bring the piston 150 into contact with the outer surface of the bearing 330. The adjustment mechanism could also be used to cause a certain amount of hydraulic pressure to be created within the closed hydraulic system.

A simple mechanical adjustment mechanism could be used throughout the life of the assembly to re-adjust the position of the power generating unit 100 in the bearing housing 300 to ensure that the piston 150 remains in contact with the outer surface of the bearing 330, and to keep a desired hydraulic pressure in the hydraulic system as normal wear accumulates over time.

A rotating shaft or rotating element of the machinery would be mounted inside the inner race 332 of the bearing 330. As the rotating shaft or rotating member mounted inside the bearing 330 rotates, the inner race 332 would rotate and the balls 334 would circulate around the bearing.

If the rotating member is not perfectly balanced, the rotating member will tend to move in a slightly eccentric fashion, with the rotating member moving slightly in a direction perpendicular to the rotational axis. Although the bearings are designed to resist lateral movements, at least some lateral movement typically occurs, however slight. As a result, each time that the heavier portion of the rotating member passes the piston 150, the piston 150 is slightly depressed.

Downward movement of the piston 150 will likely occur each time that one of the balls 334 within the bearing 330 pass the piston 150, as this configuration would result in the most direct transmission of a downward force to the piston 150. Thus, one would expect the piston to experience periodic downward movements that correspond to the passage of the balls 334 of the bearing 330.

Eccentric motion of the rotating member and the rotational movement of the balls 334 in the bearing will likely combine to cause periodic downward movements of the piston 150. Thus, each time that a ball 334 passes the piston 150 it may exert a greater or lesser force on the piston 150 depending on the rotational position of the rotating member.

The periodic depression of the piston 150 will cause periodic deformation of the piezoelectric crystal 121, which in turn will cause periodic generation of voltages on the first and second electrical leads 132, 142. This electrical energy can be used for beneficial purposes.

For example, the voltages generated by the piezoelectric crystal 121 could be used to charge a battery, a capacitor, or some other electrical power storage device. Alternatively, the voltages could be immediately used to conduct or perform some type of work. For example, the voltages could be used to drive a cooling system for the rotating machinery.

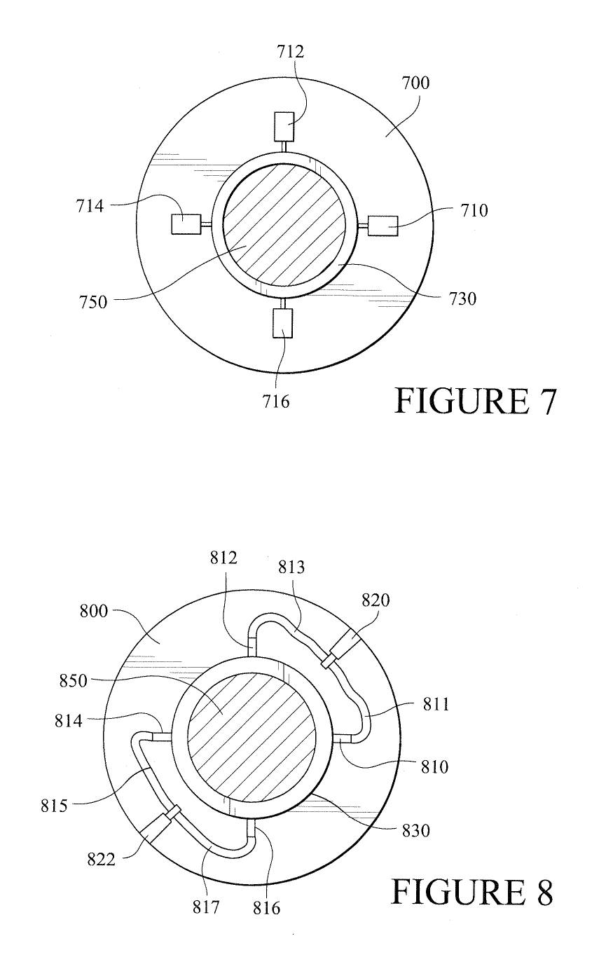

The assembly illustrated in FIGS. 3-6 includes a single electrical power generating unit 100 which is driven by lateral movements of a rotating mass. In alternate embodiments, a plurality of electrical power generating units 100 could be mounted on the machinery. FIG. 7 illustrates one embodiment in which four electrical power generating units 710, 712, 714, 716 are mounted around a bearing 730 on a bearing housing 700. A rotating shaft 750 is mounted in the bearing 730. The electrical power output by each of the electrical power generating units 710, 712, 714, 716 could be combined and used together, or the electrical power output by each unit could be used for a different purpose.

FIG. 8 illustrates another alternate embodiment. In this embodiment, remote units 810, 812, 814, 816 are mounted adjacent the outer race of a bearing 830 on a bearing housing 800. Each remote unit 810, 812, 814, 816 includes a movable member or piston that abuts the outer race of the bearing 830 on a bearing housing 800. Hydraulic lines 811, 813, 815, 817 connect the remote units 810, 812, 814, 816 to corresponding electrical power generating units 820, 822 that include piezoelectric crystals as described above. Movement of the pistons in the remote units 810, 812, 814, 816 transmits a force through hydraulic fluid in the hydraulic lines 811, 813, 815, 817 to hydraulic reservoirs in the electrical power generating units 820, 822 to cause deformation of the piezoelectric crystals and generation of a voltage.

Movements of moveable members in the first and second remote units 810, 812 create forces that deform the piezoelectric crystal in the first electrical power generating unit 820. Likewise, movements of the movable members in the third and fourth remote units 814, 816 create forces that deform the piezoelectric crystal in the second electrical power generating unit 822.

Because two different movable members both cause deformation of a single piezoelectric crystal, the locations of the remote units may be carefully selected to result in the generation of separate output voltages in response to separate movements of each movable member. For example, if the rotating member is unbalanced and is heavier on one side than on the other, one would expect the rotating member to move in an eccentric fashion. If two remote units are mounted on opposite sides of a bearing mounted on the rotating member, then one would expect the rotating member to exert a maximum force on each remote unit one time during each rotation of the movable member. But because the remote units are located on opposite sides of the bearing, the piezoelectric crystal would receive a maximum deformation force twice during each rotation of the rotating member, and the maximum forces would be applied to the piezoelectric crystal at exactly evenly spaced time intervals.

Alternatively, the remote units may be mounted such that their movable members both tend to move at the same time, resulting in a larger total force being transmitted to the piezoelectric crystal than would be possible if only one movable member was generating the force. For example, the remote units may be spaced around the outside of the bearing at angular positions that correspond to the angular positions of the balls within a bearing. This would result in the maximum forces being applied to the movable members in the remote units at the same time be each of the respective balls in the bearing.

While the embodiment illustrated in FIG. 8 shows two remote units being coupled to each electrical power generating unit, in alternate embodiments more than two remote units could be coupled to each electrical power generating unit.

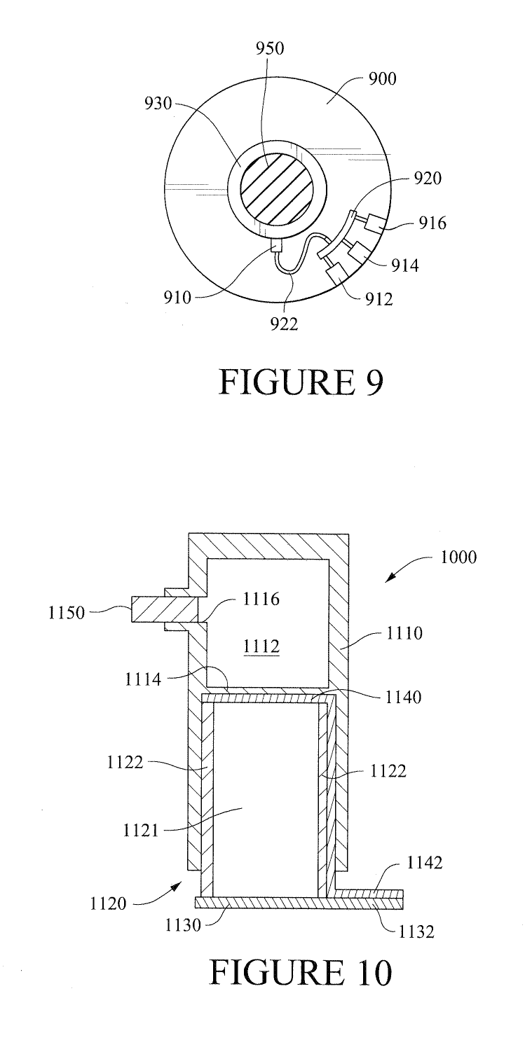

FIG. 9 illustrates another embodiment in which a single remote unit 910 creates a force which is transmitted through a single hydraulic line 922 to hydraulic reservoirs inside three separate electrical power generating units 912, 914, 916. Although FIG. 9 illustrates three electrical power generating units being driven by a single remote unit, greater or lesser numbers of the electrical power generating units could be coupled to a single remote unit 910.

In still other embodiments, multiple remote units could be coupled to multiple electrical power generating units through a common hydraulic channel.

In the embodiment illustrated in FIGS. 1 and 2, a piston or moveable member 150 is mounted at the top of the housing 110. FIG. 10 illustrates alternate embodiment in which the piston or moveable member 1150 is mounted on the side wall of a housing 1110 of an assembly for converting motion into electrical power 1000. The piston 1150 is mounted in a hydraulic passageway 1116 which leads into a hydraulic reservoir 1112. A bottom wall 1114 of the hydraulic reservoir 1112 will press against a piezoelectric crystal 1121 of a piezoelectric element 1120 when hydraulic pressure is generated in the hydraulic reservoir 1112.

The embodiment illustrated in FIG. 10 also includes a first electrical lead 1132 leading a first electrode 1130 mounted on the bottom of the piezoelectric crystal 1121. Likewise, a second electrical lead 1142 travels along the inside of the housing 1110 to the top of the piezoelectric element 1120 where it is connected to a second electrode 1140 at the top of the piezoelectric crystal 1121. This embodiment also includes an electrical insulation layer 1122 which surrounds the piezoelectric crystal to insulate it from the housing 1110.

Although some of the foregoing description involved a mechanism with a ball bearing, any type of bearing could be used. For example, the power generating unit 100 could be mounted on a bearing housing having a roller bearing, a needle bearing, a fluid filled bearing, or virtually any other type of bearing. The same principles described above would apply.

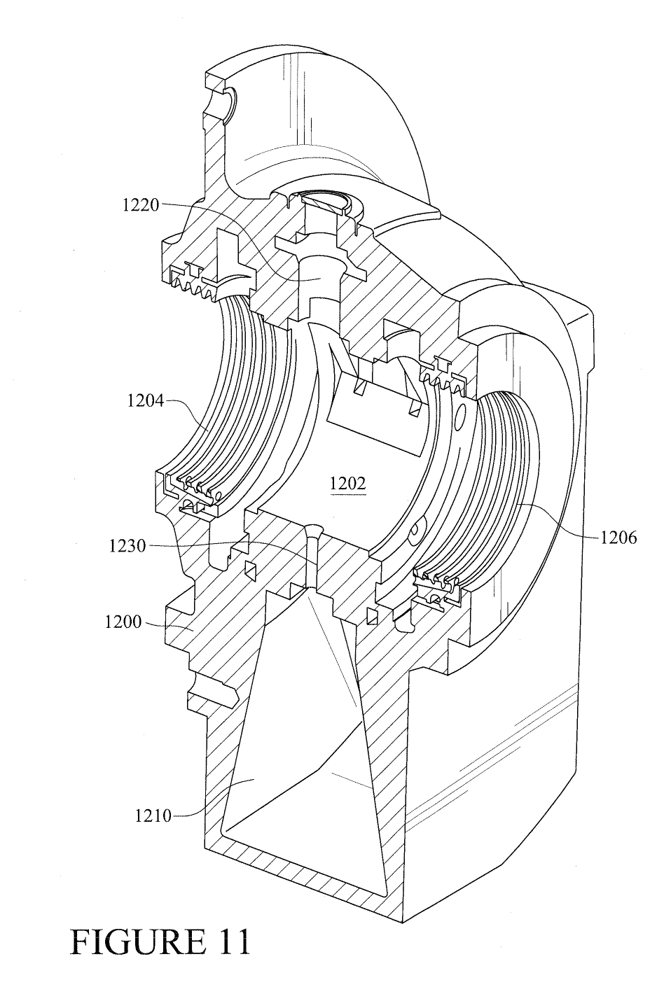

FIGS. 11-15 illustrate another embodiment where a power generating unit 100 is used in a fluid filled bearing.

As shown in FIG. 11, a bearing housing 1200 includes a central area 1202 which will hold a fluid bath surrounding a rotating shaft. Seals 1204, 1206 seal around the exterior of the shaft to keep the fluid within the bearing. A power generating unit aperture 1210 is designed to receive and hold a power generating unit 100, such as the one illustrated in FIGS. 1 and 2. A fluid fill passageway 1220 allows fluid to be added to the bearing housing 1200 once the rotating shaft has been mounted within the bearing housing 1200. A fluid passageway 1230 extends from an aperture in the central area 1202 down to the power generating unit aperture 1210.

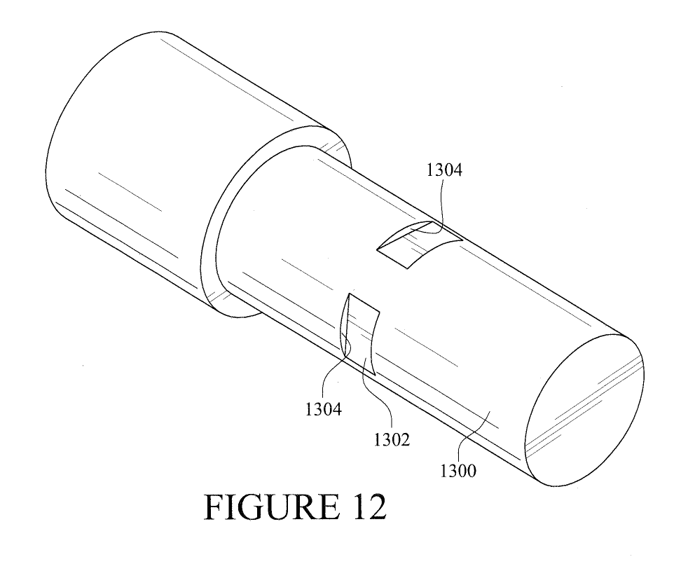

FIG. 12 illustrates a rotating shaft 1300 that would be mounted in the bearing housing 1200 shown in FIG. 11. The portion of the rotating shaft that would be located in the central area 1202 of the bearing housing 1200 includes multiple depressions 1302. Although the depressions illustrated in FIG. 12 have a flat bottom surface connecting two points on the curved outer surface of the rotating shaft 1300, in alternate embodiments the depressions could take other shapes. Also, although the sidewalls 1304 of the depressions in the embodiment illustrated in FIG. 12 are flat and parallel, in alternate embodiments the sidewalls may have a shape other than a flat surface, and they may not be parallel to one another.

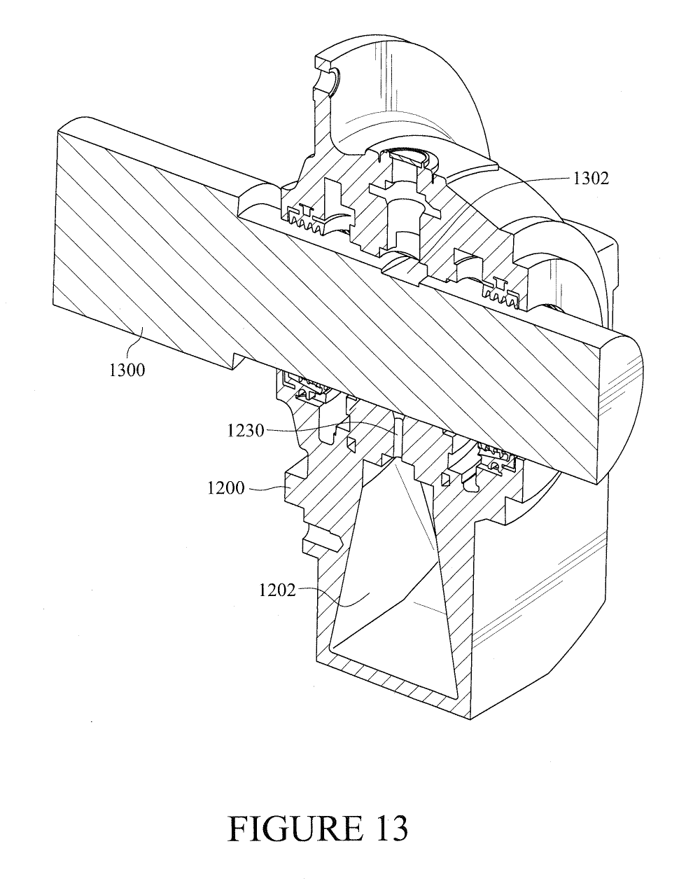

FIG. 13 illustrates the rotating shaft 1300 mounted in the bearing housing 1200. The depressions 1302 on the rotating shaft 1300 are positioned such that as the shaft rotates, the depressions 1302 will pass over the top of the fluid passageway 1230 leading to the power generating unit aperture 1210.

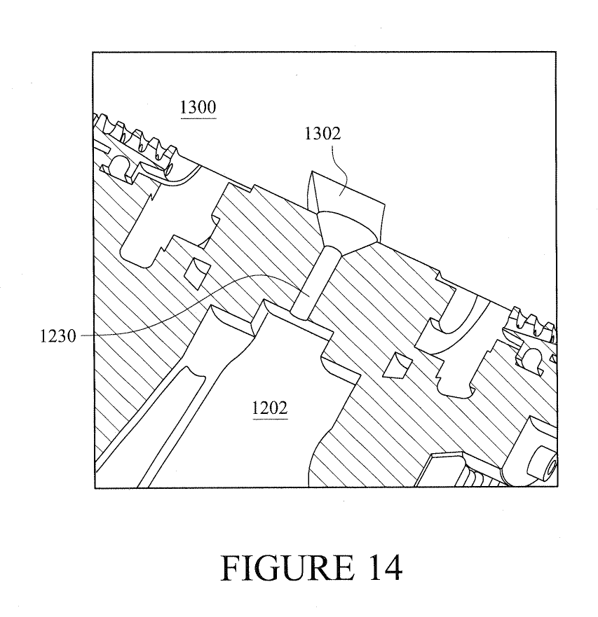

FIG. 14 provides an enlarged view of the area surrounding the fluid passageway 1230. In FIG. 14, one of the depressions 1302 on the rotating shaft 1300 is located directly over the fluid passageway 1230. This view also illustrates that the upper end of the fluid passageway 1230 flares outward to provide an enlarged diameter.

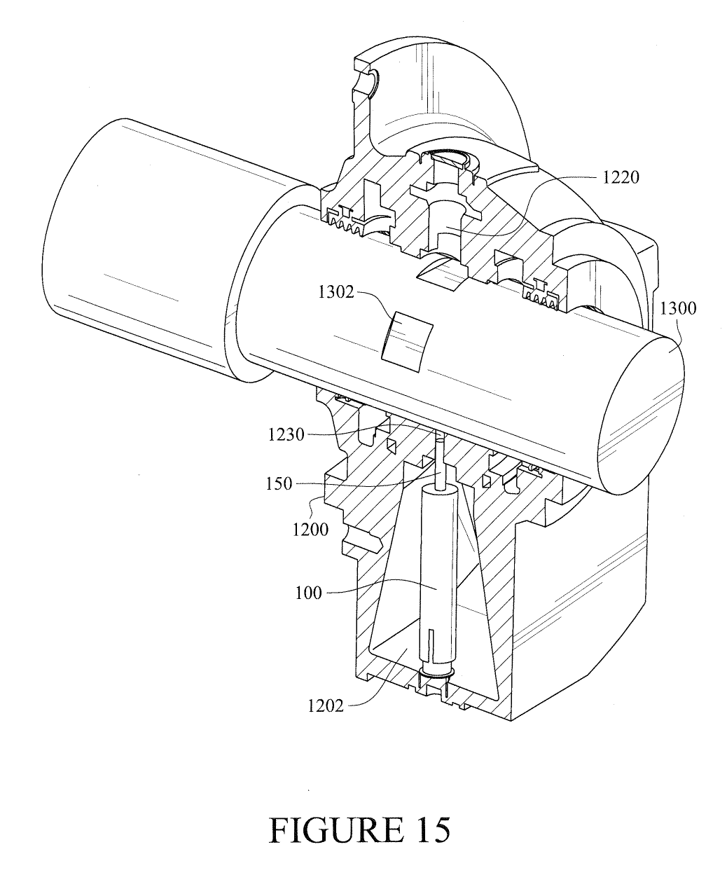

FIG. 15 illustrates how a power generating unit 100 is mounted in the power generating unit aperture 1202. The piston 150 extends partially into the fluid passageway 1230. Sidewalls of the piston 150 may be provided with a sealing member so that a seal is formed between the fluid passageway 1230 and the piston 150.

Once the assembly is configured as illustrated in FIG. 15, fluid would be added to the assembly through the fluid fill passageway 1220. The fluid would surround the exterior of the rotating shaft to provide a fluid bearing for the shaft.

As the shaft rotates, movement of the depressions 1302 past the upper end of the fluid passageway 1230 would cause fluid to periodically be forced down into the fluid passageway 1230. This action will cause the piston to be periodically depressed as the shaft rotates. As described above, movement of the piston will cause the piezoelectric crystal in the power generating unit to output a voltage.

The number and orientation of the depressions on the exterior of the rotating shaft can be selected to cause the power generating unit 100 to output a desired pattern of voltages. Also, the shape of the depressions could be tailored to vary the amount that the piston is depressed, and/or the speed and timing of the movement of the piston during each depression.

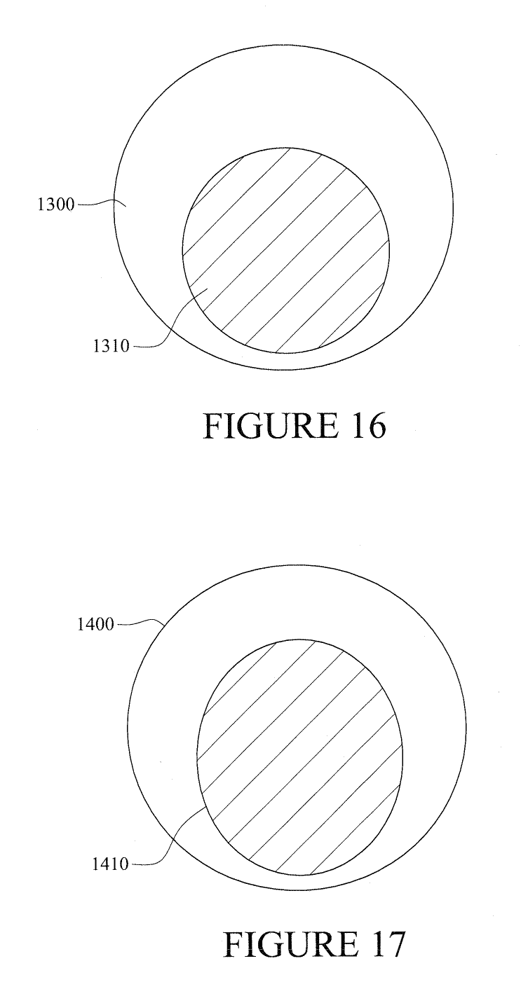

FIGS. 16 and 17 illustrate the rotating shaft of an alternate embodiment. In FIG. 16, the portion of the rotating shaft 1300 which will be positioned over top of the fluid passageway 1230 has a smaller diameter than other portions of the rotating shaft 1300. Also, center of the smaller diameter portion 1310 is offset from the rotational center of the rotating shaft 1300. As a result, the smaller diameter portion will alternately come closer to and move farther away from the top of the fluid passageway 1230 of the bearing housing 1200. This action of the smaller diameter portion 1310 of the rotating shaft will cause fluid to pulse downward and upward within the fluid passageway 1230, which will cause periodic movement of the piston of the power generating unit 100.

FIG. 17 illustrates a rotating shaft 1400 that also has a smaller diameter portion 1410 at a position that will be located over the fluid passageway 1230 of the bearing housing 1200. In this embodiment, the smaller diameter portion 1410 has an elliptical shape. The elliptical shape serves to vary the way in which the fluid pulses into and out of the fluid passageway 1230, and thus the way in which the piston 150 of the power generating unit 100 would move. In the embodiment illustrated in FIG. 17, the long axis of the ellipse is parallel to the axis along which the smaller diameter portion is offset. In alternate embodiments, the long axis of the ellipse could be oriented in different directions.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. An assembly for converting motion into electrical power, comprising:
a frame;
a rotating member mounted on the frame;
a bearing that, at least in part, rotationally supports the rotating member on the frame;
at least one electrical power generating unit mounted on the frame and having a movable member that is operatively coupled to the bearing such that rotation of the rotating member results in movement of the movable member, and wherein the at least one electrical power generating unit converts movement of the movable member into electrical power.

2. The assembly of claim 1, wherein the at least one electrical power generating unit comprises a piezoelectric element, wherein the movable member is operatively coupled to the piezoelectric element such that movements of the movable member result in a force being applied to the piezoelectric element, the force causing the piezoelectric element to generate a voltage.

3. The assembly of claim 2, wherein the at least one electrical power generating unit includes a force transmitting unit that is operatively coupled to the movable member and the piezoelectric element, and wherein movements of the movable member cause the force transmitting unit to generate a force that is operatively coupled to the piezoelectric element.

4. The assembly of claim 3, wherein the force transmitting unit provides a mechanical advantage such that a magnitude of a force applied to the piezoelectric element by the force transmitting unit is greater than a magnitude of a force applied to the force transmitting unit by the movable member.

5. The assembly of claim 4, wherein the force transmitting unit comprises a hydraulic assembly that is operatively coupled to the movable member and the piezoelectric element.

6. The assembly of claim 3, wherein the movable member comprises a plurality of movable members that are all operatively coupled to the force transmitting unit such that movements of any of the movable members results in a force being applied to the piezoelectric element.

7. The assembly of claim 3, wherein the piezoelectric element comprises a plurality of piezoelectric elements that are operatively coupled to the force transmitting unit such that a movement of the movable member causes forces to be applied to all of the piezoelectric elements.

8. The assembly of claim 2, wherein the bearing is a ball bearing, and wherein each time a ball of the ball bearing moves past the movable member, a force is applied to the movable member by the bearing to cause the movable member to move.

9. The assembly of claim 1, wherein the at least one electrical power generating unit comprises a plurality of electrical power generating units that are mounted on the frame around an outer circumference of the bearing.

10. The assembly of claim 1, wherein the rotating member is the rotor of an electrical motor.

11. The assembly of claim 1, wherein the bearing is a fluid bearing, and wherein the fluid surrounding the rotating shaft is operatively coupled to the movable member such that rotation of the rotating shaft causes movement of the movable member.

12. An electrical power generating unit that converts movement into electrical power, comprising:
a housing;
a piezoelectric element mounted on the housing;
a movable member; and
a force transmitting unit that is operatively coupled to the movable member and the piezoelectric element, wherein movements of the movable member cause the force transmitting unit to generate a force that is operatively coupled to the piezoelectric element, and wherein a force applied to the piezoelectric element by the force transmitting unit causes the piezoelectric element to generate a voltage.

13. The electrical power generating unit of claim 12, wherein the force transmitting unit provides a mechanical advantage such that when the movable member applies a first force to the force transmitting unit, the force transmitting unit causes a second force having a greater magnitude than the first force to be applied to the piezoelectric element.

14. The electrical power generating unit of claim 12, wherein the force transmitting unit comprises a hydraulic assembly that is operatively coupled to the movable member and the piezoelectric element.

15. The electrical power generating unit of claim 14, wherein the hydraulic assembly comprises:
a hydraulic reservoir located within the housing and filled with hydraulic fluid, wherein the hydraulic fluid in the hydraulic reservoir is operatively coupled to the piezoelectric element; and
a hydraulic passageway in the housing filled with hydraulic fluid and having a first end operationally coupled to the movable member and a second end that opens into the hydraulic reservoir such that when the movable member moves, it applies a force to the hydraulic fluid in the hydraulic passageway, the force being transmitted through the hydraulic fluid in the hydraulic passageway to the hydraulic fluid in the hydraulic reservoir.

16. The electrical power generating unit of claim 15, wherein the movable member comprises a piston mounted on the housing and having an end that protrudes into the hydraulic passageway.

17. The electrical power generating unit of claim 15, wherein the hydraulic assembly is configured such that when a first force is applied to the movable member, the hydraulic fluid in the hydraulic reservoir causes a second force having a greater magnitude than the first force to be applied to the piezoelectric element.

18. The electrical power generating unit of claim 12, wherein the movable member is mounted on the housing.

19. The electrical power generating unit of claim 12, further comprising a remote unit that is separate from the housing, wherein the movable member is part of the remote unit.

20. The electrical power generating unit of claim 19, wherein the remote unit comprises a plurality of remote units, each remote unit having its own movable member.

21. The electrical power generating unit of claim 19, wherein the piezoelectric element comprises a plurality of piezoelectric elements, all of which are operatively coupled to the force transmitting unit such that movements of the movable member cause the force transmitting unit to generate a force that is operatively coupled to all of the piezoelectric elements.
